(19) United States
(12) Patent Application Publication
(10) Pub. No.: US 2015/0294019 A1
(43) Pub. Date: Oct. 15, 2015

(54) WEB BROWSING ACTIVITY FLOW

(71) Applicant: International Business Machines Corporation, Armonk, NY (US)

(72) Inventors: Al Chakra, Apex, NC (US); Liam Harpur, Dublin (IE); John Rice, Tramore (IE)

(73) Assignee: International Business Machines Corporation, Armonk, NY (US)

(21) Appl. No.: 14/249,792

(22) Filed: Apr. 10, 2014

(51) Int. Cl. G06F 17/30

(52) U.S. Cl. CPC G06F 17/30876; G06F 17/3089

(57) ABSTRACT

A method for creating a web browser activity flow is disclosed. The method can include sending, to a browser information database, a content request related to a first topic, wherein the content request is sent by a client device. The method can include collecting, from a browsing information database having one or more web pages related to the first topic, web browsing information. The web browsing information can include an aggregated web browsing history from a plurality of individual web browsers that access the browsing information database. The method can include selecting a set of web pages from the aggregated web page browsing history based on the web browsing information and the content request. The method can also include generating a web browser activity flow having the set of web pages. The method can also include providing the web browser activity flow to a web browser of the client device.

### BACKGROUND

The present disclosure relates to computer networks, and more specifically, to web browsing.

The amount of data and information available on the internet and other communication networks is growing rapidly. Web browsers are one tool by which a user may find desired information. As the amount of available information increases, the need for managing web browsers may also increase.

### SUMMARY

Aspects of the present disclosure, in certain embodiments, are directed toward a method for creating a web browser activity flow. In certain embodiments, the method can include sending, from a client device, a content request related to a first topic. The content request may, for example, be a page load or a search query. In certain embodiments, the method can include collecting, from a browsing information database having one or more web pages related to the first topic, web browsing information. This can include an aggregated web page browsing history from a plurality of individual web browsers that access the browsing information database. In certain embodiments, the method can include selecting a set of web pages from the aggregated web page browsing history based on the web browsing information and the content request. In certain embodiments, the method can include generating a web browser activity flow having the set of web pages. In certain embodiments, the method can include providing the web browser activity flow to a web browser of the client device.

Aspects of the present disclosure, in certain embodiments, are directed toward a method for creating a web browser activity flow. In certain embodiments, the method can include receiving, in a web browser, a content request. The content request may, for example, be a page load or a search query. In certain embodiments, the method can include identifying a social network related to the content request. In certain embodiments, the method can include accessing aggregate web browsing information from the social network. The aggregate web browsing information can, in certain embodiments, be browsing history data retrieved from individual web browsers accessing the social network. In certain embodiments, the method can include providing an activity flow based on the aggregate web browsing information.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 is a diagrammatic illustration of an example computing environment, according to embodiments.

FIG. 2 illustrates an example computer environment for creating an activity flow, according to embodiments.

FIG. 3 is a flowchart illustrating a method for creating a web browser activity flow, according to embodiments.

FIG. 4 is a flowchart illustrating a method for creating a web browser activity flow, according to embodiments.

FIG. 5 illustrates modules of a system for creating an activity flow, according to embodiments.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to various embodiments of a system and method for creating a web browser activity flow. More particular aspects relate to generating the web browser activity flow based on web browsing information. The method may include sending, from a web browser, a content request related to a first topic. The method may include collecting, from a browsing information database having one or more web pages related to the first topic, web browsing information including an aggregated web page browsing history from a plurality of individual web browsers that access the browsing information database. The method may also include selecting a set of web pages from the aggregated web page browsing history based on the web browsing information and the content request. The method may also include generating a web browser activity flow having the set of web pages. The method may also include providing the web browser activity flow to the web browser.

As the amount of information available over computer networks, such as the Internet, rapidly increases, web browsers have become an important tool in assisting users with accessing and gathering data. Many web browsers provide back and forward functionality that allow users to jump to previously viewed content. Aspects of the present disclosure relate to the recognition that, in certain embodiments, the process of finding relevant content on the Internet can be a time-consuming process. Accordingly, aspects of the present disclosure relate to methods and systems for providing a web browser activity flow of web pages based on the aggregated browsing data of a social network. The activity flow can be a set of web pages related to a particular topic or subject, and can be recommended to a user based on aggregate social browsing information. For example, using the back and forward functionality of a web browser, the present disclosure can provide a means of browsing a socially combined traffic flow of content based on a social community to which a user belongs. The present disclosure may provide benefits associated with increased browsing efficiency and relevancy of internet content.

Aspects of the present disclosure include a method and system for creating a web browser activity flow. More particular aspects relate to generating the web browser activity flow based on web browsing information. The method and system may work on a number of devices and operating systems. Aspects of the present disclosure include sending a content request related to a first topic. The content request may be sent from a web browser. Aspects of the present disclosure may include collecting web browsing information from a browsing information database having one or more web pages related to the first topic. The one or more web pages may include, for example, a social networking site. Collecting web browsing information from the browsing information database having one or more web pages related to the first topic pages can include requesting the web browsing information from the browsing information database. For example, requesting the web browsing information from the browsing information database can include using an application programming interface configured to access the browsing information database. Further, collecting the web browsing information from the database can include using a linking token communicatively connected to a web browser and the browsing information database.

Aspects of the present disclosure include selecting a set of web pages from the aggregated web browsing history. The set of web pages may be based on the web browsing information and the content request. The web browsing information may, as an example, be an aggregated browsing history retrieved from individual web browsers accessing the first set of web pages. Aspects of the present disclosure can include generating a web browser activity flow based on the web browsing information. The web browsing activity flow may include the set of web pages. The method can also include determining, by an activity flow processing engine, that a first subset of the set of web pages is unrelated to a first topic of the set of web pages. Further, the method can include filtering the set of web pages to remove the first subset. Filtering the set of web pages can be performed in response to determining that the first subset of the set of web pages is unrelated to the first topic of the set of web pages. The method can also include providing a second subset of the set of web pages that is related to the first topic of the set of web pages.

Aspects of the present disclosure can include providing the web browser activity flow to a web browser. The web browser may, for instance, be active on a computer, tablet, smart phone, or other device. Providing the activity flow can include generating, in response to a content request, a set of subsequent web page recommendations based on the browsing information. Further, providing the activity flow can include generating a set of previous web page recommendations based on the web browsing information.

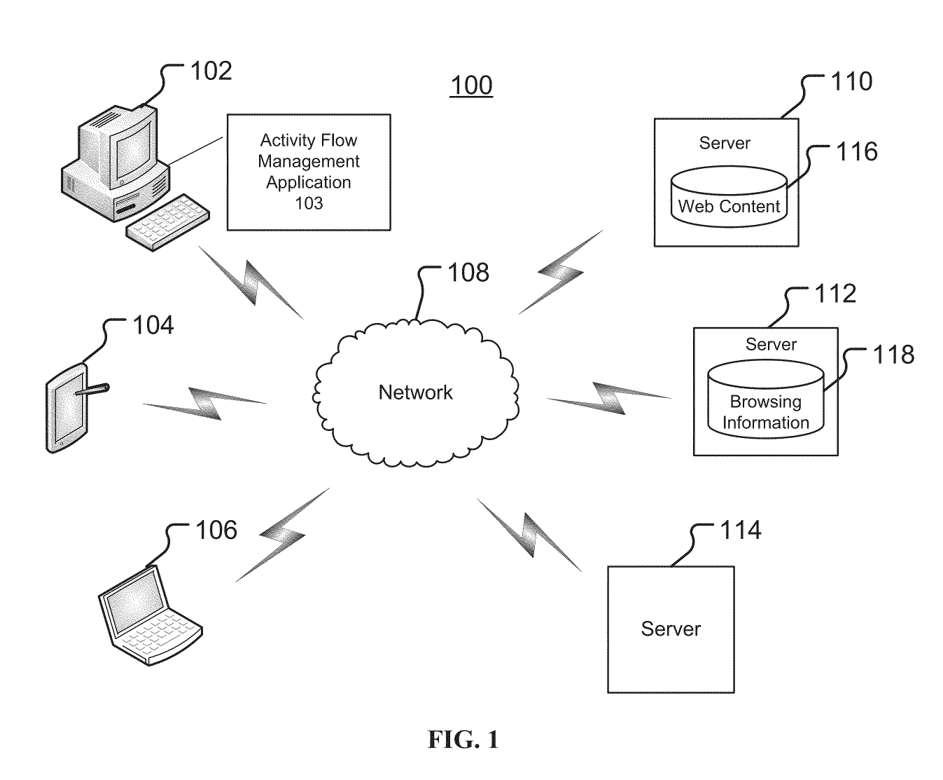

Turning now to the figures, FIG. 1 is a diagrammatic illustration of an example computing environment, consistent with embodiments of the present disclosure. Specifically, the environment 100 can include one or more client devices 102, 104, 106 and one or more remote devices 110, 112, 114. Client devices 102, 104, 106 and remote devices 110, 112, 114 may be remote from each other and communicate over a network 108 in which the remote devices 110, 112, 114 comprise a central hub from which client devices 102, 104, 106 can establish a communication connection. Alternatively, the remote devices 110, 112, 114 and client devices 102, 104, 106 may be configured in any other suitable relationship (e.g., in a peer-to-peer or other relationship).

The network 108 can be implemented by any number of any suitable communications media (e.g., wide area network (WAN), local area network (LAN), Internet, Intranet, etc.). Alternatively, client 102, 104, 106 and remote devices 110, 112, 114 may be local to each other, and communicate via any appropriate local communication medium (e.g., local area network (LAN), hardwire, wireless link, intranet, etc.).

Client device 102 can include an activity flow management application 103. The activity flow management application 103 can facilitate sending a content request related to a first topic, collecting web browsing information from a browsing information database, selecting a set of web pages based on the web browsing information and the content request, generating a web browser activity flow including the set of web pages, and providing the activity flow to a web browser. The activity flow management application 103 can be configured to access one or more databases or other computer systems for content that is associated with the activity flow management application 103. The databases or content may, for example, be hosted on a remote device such as remote devices 110, 112, 114.

Client devices 102, 104, 106 can enable users to submit requests (e.g., content access requests or browsing information requests) to remote devices 110, 112, 114 for verification or to retrieve content. For example, the client devices 102, 104, 106 may present a graphical user interface (e.g., in the form of a web browser or any other suitable software module) or other interface (e.g., command line prompts, menu screens, etc.) to receive information requests/content requests from users for submission to one or more remote devices 110, 112, 114. The remote devices 110, 112, 114 may then verify or deny the information requests/content access requests.

In certain embodiments, one or more remote devices 110, 112, 114 may include one or more databases 116. For example, the database 116 of remote device 110 may, in certain embodiments, include web content, such as web sites, data storage, or enterprise applications. A database 118 of remote device 112 may include browsing information. The browsing information may, in certain embodiments, be aggregate browsing histories retrieved from individual web browsers of users accessing the database 118.

Client devices 102, 104, 106 and remote devices 110, 112, 114 may be implemented by conventional or other computer systems equipped with a display or monitor, a base, where the base includes at least one processor, memory and/or internal or external network interface or communications devices (e.g., modem, network cards, etc.), optional input devices (e.g., a keyboard, mouse, or other input device); and any commercially available and custom software (e.g., browser software, communications software, server software, natural language processing software, search engine and/or web crawling software, filter modules for filtering content based upon predefined criteria, etc.). The computer systems may include server, desktop, laptop, and hand-held devices. For example, the computer systems may include tablets, cell phones, smart phones, personal digital assistants, or other mobile devices. The computer systems may include one or more modules or units to perform the various functions of present disclosure embodiments described below (e.g., sending a content request related to a first topic, collecting web browsing information from a browsing information database, selecting a set of web pages based on the web browsing information and the content request, generating a web browser activity flow including the set of web pages, and providing the activity flow to a web browser, etc.), and may be implemented by any combination of any quantity of software and/or hardware modules or units.

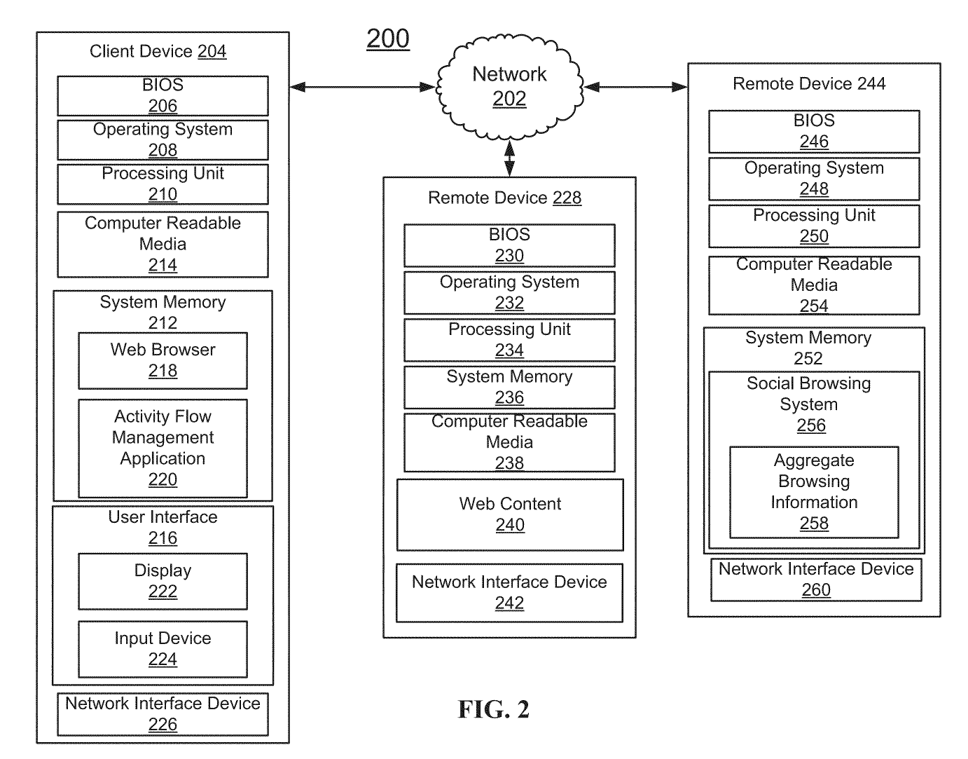

FIG. 2 illustrates an example system 200 for creating an activity flow, consistent with embodiments of the present disclosure. Aspects of FIG. 2 are directed toward a system 200 that facilitates the implementation of an application for creating a web browser activity flow. Consistent with various embodiments, the system 200 can include one or more remote devices 228, 244 and a client device 204 communicatively connected via a network 202. The remote device 228 can include web content 240. As an example, in certain embodiments, the web content 240 can include internet web pages, online journal articles, videos, images, and the like. The remote device 244 can include a social browsing system 256. The social browsing system 256 can include aggregate browsing information 258. The social browsing system 258 can be configured to retrieve and store aggregate browsing information 258. In certain embodiments, the aggregate browsing information 258 can be accessible by the client device 204.

As shown in FIG. 2, the client device 204, remote device 228, and remote device 244 can include a network interface device 226, 242, 260, a BIOS (basic input-output system) 206, 230, 246, an operating system 208, 232, 248 one or more processors or processing units 210, 234, 250, a system memory 212, 236, 252, and some form of computer-readable media 214, 238, 254. The network interface device 226, 242, 260 can facilitate communication between the client device 204, remote device 228, remote device 244, and the network 202. In certain embodiments, the various components of the client device 204, remote device 228, and remote device 244, respectively, can be coupled together by a system bus.

As shown in FIG. 2, the client device 204, remote device 228, and remote device 244 can include one or more forms of computer-readable media 214, 238, 254. For example, computer-readable media can include storage media, such as random-access memory (RAM), read-only memory (ROM), electrically erasable programmable read-only memory (EEPROM), flash memory, hard disks, optical disk storage, or other mediums that can be used to store information that can be accessed by the client device 204, remote device 228, and remote device 244, respectively. Additionally, computer-readable media can include communication media, such as computer-readable instructions, data structures, and program modules. Wired media, such as a wired network or a direct-wired connection, and wireless media, such as acoustic, radio frequency, infrared, and other wireless media are further examples of communication media. Combinations of the above are also included within the scope of computer-readable media.

In certain embodiments, the client device 204, remote device 228, and remote device 244 can include a BIOS 206, 230, 246 and an operating system 208, 232, 248 accessible by the system memory 212, 236, 252 and the processing unit 210, 234, 250. The BIOS 206, 230, 246 and the operating system 208, 232, 248 can facilitate the transfer of information between elements within the client device 204, remote device 228, and remote device 244, respectively as well as the implementation of application programs and other program modules. A user interface 216 can also be linked to the client device 204 that allows a user to interact with the application programs and program modules of the client device 204. For example, the user interface 216 can include a display 222 such as a computer monitor, and one or more input devices 224 such as a keyboard, a touch screen, or a pointing device (e.g., a mouse, trackball, pen, or touch pad.)

Consistent with various embodiments, the client device 204 can include a web browser 218. The web browser 218 can be executable by the client device 204, and can be responsive to user input for initiating a content request or information request. In certain embodiments, the web browser 218 can be configured to communicate with remote device 228 and access web content 240. As an example, a user could submit a request to view a desired web page via the web browser 218. The client device 204 could contact the remote device 228 to access the web content 240 based on the user's request, and provide the desired content to the user via the web browser 218.

Consistent with various embodiments, the client device 204 can also include an activity flow management application 220. The activity flow management application 220 can be communicatively coupled to the web browser 218. In certain embodiments, the activity flow management application 220 can be configured to generate an activity flow based on aggregate web browsing information, and provide the activity flow to the web browser 218. Consistent with various embodiments, the activity flow may include a set of web pages.

Consistent with various embodiments, the remote device 244 can include a social browsing system 256. The social browsing system 256 can be configured to collect user browsing information and statistics, and maintain this aggregate browsing information 258 in a browsing information database. The browsing information database can be configured to be accessible by the client device 204. In certain embodiments, the activity flow management application 220 can access the aggregate browsing information 258, and use it to generate an activity flow to provide to the web browser 218.

As an example, a user of the client device 204 may use the web browser 218 to submit a request for content or information, such as web content 240. Based on the content request, the activity flow management application 220 can submit a request to the social browsing system 256 for aggregate browsing information 258 related to the content request. Based on the aggregate browsing information 258, the activity flow management application 220 can generate an activity flow including a list of suggested web pages. In certain embodiments, the activity flow management application 220 can provide the activity flow to the web browser 218.

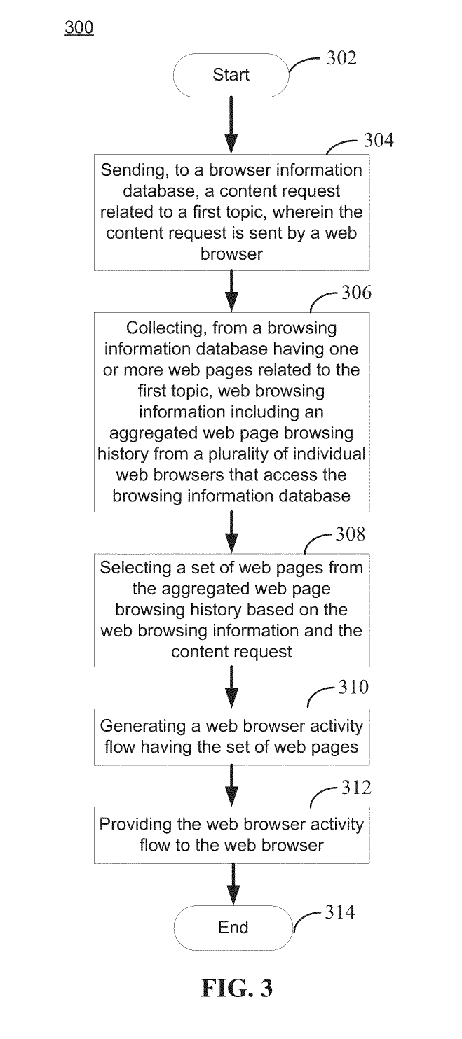

FIG. 3 is a flowchart illustrating a method 300 for creating a web browser activity flow, consistent with embodiments of the present disclosure. Aspects of FIG. 3 are directed toward providing an activity flow containing a set of recommended web pages to a web browser. The method 300 may begin at block 302 and end at block 314. Consistent with various embodiments, the method 300 can include a sending block 304, a collecting block 306, a selecting block 308, a generating block 310, and a providing block 312.

Consistent with various embodiments, at block 304 the method 300 can include sending a content request related to a first topic to a web browsing information database. The first topic may be a particular subject or theme, such as scuba diving, ant farms, or pet hedgehogs. Other first topics are also possible. The content request may be sent from a web browser of a client device. For example, the content request may be sent via a dialog window communicatively connected to the web browser. In certain embodiments, the content request can be sent to a browsing information database. The browsing information database may maintain web browsing information and statistics.

Consistent with various embodiments, at block 306 the method 300 can include collecting web browsing information for a first set of web pages. The web browsing information can be aggregate browsing information (e.g., aggregate browsing information 258 of FIG. 2) and statistics gathered from a group of users, and may represent browsing trends and tendencies of the group of users. For example, the browsing trends and tendencies may indicate how the internet browsing habits of users may vary depending on the time of the day, day of the week, or in response to certain news topics, sporting events, or other factors. In certain embodiments, the web browsing information can be browsing history data gathered from individual web browsers and stored within a social browsing system (such as social browsing system 256 of FIG. 2). For example, the browsing history data may include an archive of web pages previously viewed by one or more users. The web browsing information may include information regarding web site access frequency (e.g., how many times a web page is accessed in a given time period), browsing duration (e.g., the length of time a user browses the internet in one session), search engine usage frequency (e.g., how often a user makes use of a search engine while browsing), popular topics (which subject matters a user often researches), and the like.

In certain embodiments, the web browsing information may indicate a set of web pages viewed in sequence by the group of users. For example, the web browsing information may indicate that after viewing a particular web page pertaining to computer graphics cards, users then viewed a page pertaining to computer processor units. In certain embodiments, the web browsing information may be related to a particular topic or subject matter. For example, in certain embodiments, the web browsing information may be related to renewable energy sources. In certain embodiments, the web browsing information may be related to automobiles. In certain embodiments, the web browsing information may be related to rock 'n roll bands. Other topics are also possible.

Consistent with various embodiments, the browsing information database may have one or more web pages. The one or more web pages may, for example, include a social networking site. In certain embodiments, the one or more web pages may also be a digital encyclopedia, an email hosting site, online discussion forum, or other type of web site. The one or more web pages of the browsing information database may allow users to join one or more communities related to one or more different topics or subject matters. The communities may, for instance, be a group of people interested in a particular topic. For example, in certain embodiments, the one or more web pages may allow users to join communities related to renewable energy resources, automobiles, or rock 'n roll bands. Communities related to other topics are also possible.

As an example, in certain embodiments, a user may be part of a social network, and belong to a community of users researching whale migratory patterns. The user may make use of a digital encyclopedia to obtain information regarding whale migrations. For instance, the user may load a page pertaining to whales in the Southern Hemisphere. In response to loading the page, the method 300 may include collecting aggregate web browsing information of the users belonging to the whale migration research community, and generate an activity flow. The activity flow may, in certain embodiments, be a set of web pages related to whales that inhabit the Southern Hemisphere. For instance, according to the present example, the activity flow may include pages related to blue whales that were viewed by users of the whale migration research community. In certain embodiments, the web pages may be organized in the order in which they were viewed by the users of the whale migration research community.

Consistent with various embodiments, collecting the web browsing information can include submitting a request to a browsing information database to access the web browsing information. In certain embodiments, the web browsing information can be collected in response to receiving a content request (e.g., search query, page load, etc.) from a user. In certain embodiments, the web browsing information can be maintained in a browsing information database accessible by one or more client devices (e.g., client device 204 of FIG. 2). The web browsing information can be accessed in one of a number of different ways. For example, in certain embodiments, collecting the web browsing information can include using an application programming interface (API) that specifies a routine for accessing the browsing information database and retrieving the web browsing information. In certain embodiments, collecting the web browsing information can include using a linking token configured to operate in conjunction with a web browsing application (e.g, web browser 218 of FIG. 2). The linking token may, for example, be a widget or browser extension configured to maintain a persistent communicative connection with the browsing database and access the web browsing information. Aspects of the linking token may transmit packets having specific data pertaining to the web browsing information. The number and content of the transmitted packets may be collected and analyzed.

Consistent with various embodiments, at block 308 the method 300 can include selecting a set of web pages from the aggregated web page browsing history. In certain embodiments, the set of web pages may be selected based on the web browsing information and the content request. Further, in certain embodiments, selecting the set of web pages may be based on a number of view counts for one or more pages that is above a threshold view count value. In certain embodiments, the web pages of the aggregated browsing history can be ranked based upon a user rating system, where pages can be rated by users based on their relevance to a particular topic or subject. Other factors can also be considered when selecting the set of web pages.

Consider the following example. A user may be a member of a coin collecting community on a social network, and may submit a search query related to coin collecting in a search engine. As described herein, the method 300 can include collecting web browsing information from a browsing information database coupled to the social network to which the user belongs. As an example, the method 300 may collect an aggregate web page browsing history from the browsing information database. The aggregate web page browsing history may include a great number of web sites viewed by the members of the coin collecting community. Selecting a set of web pages from the aggregated web browsing history may include analyzing the pages of the web browsing history, and choosing a set of pages that were highly ranked or highly viewed by the members of the coin collecting community. For example, a particular page may have a low view count, but be highly ranked by a large percentage of the users that have viewed it, and be selected as one page of the set of pages. In another case, a particular page may not have as high of a user rating, but may have a very high view count, and also be selected as one page of the set of pages. Other factors can also be considered when choosing the set of pages.

Consistent with various embodiments, at block 308 the method 300 can include generating, based on the web browsing information, a web browser activity flow having the set of web pages. The set of web pages may, for example, be a list of recommended web pages. In certain embodiments, the set of web pages may be related to one or more topics, and may be associated with a community of the first set of web pages (e.g., a community of a social networking site). Consistent with various embodiments, the set of web pages may be structured to represent a browsing flow (e.g., a “path” of viewed web pages) based on the web browsing information.

Consistent with various embodiments, generating the web browser activity flow can be based on the web browsing information. For example, if the web browsing information indicates that a threshold number of users viewed a set of web pages in a particular order, the web browser activity flow can be structured to present the set of web pages in the order in which they were viewed by the threshold number of users. As an example, consider a scenario wherein a threshold number of users, after viewing a web page related to famous harmonica players, proceeded to view a page related to beginner harmonica lessons, and then to a web page related to harmonica sheet music. The set of web pages of the web browser activity flow could be organized to present these pages in the order in which they were viewed by the threshold number of users. In certain embodiments, certain web pages can have a weighting value assigned by a user rating system, and the web browser activity flow can include those pages that have a weighting value above a threshold value.

Consistent with various embodiments, aspects of the present disclosure relate to determining that a first subset of the set of web pages is unrelated to a first topic of the set of web pages. Determining that the first subset of the set of web pages is unrelated to a first topic of the set of web pages can, in certain embodiments, be based on metadata associated with web pages (e.g., web page tags, etc.) of the first subset. Further, in certain embodiments, the method 300 can include filtering the set of web pages to remove the first subset. Filtering the set of web pages to remove the first subset can be performed in response to determining that a first subset of the set of web pages is unrelated to a first topic of the set of web pages. As an example, consider that the set of web pages is related to beekeeping. The method 300 can include determining that a first subset of the set of web pages is related to spelling bees, and not substantially relevant to the set of web pages. In response to determining that the first subset (e.g., the web pages related to spelling bees) is not relevant to the set of web pages, the method 300 can include filtering the set of web pages and removing the web pages related to spelling bees. Accordingly, a second subset of the set of web pages that is substantially relevant to beekeeping may be provided. In certain embodiments, determining that the first subset is unrelated to a first topic of the set of web pages can be performed by an activity flow processing engine configured to evaluate metadata associated with each page of the set of web pages.

Consistent with various embodiments, at block 310 the method 300 can include providing the activity flow to a web browser. Providing the activity flow to a web browser can include configuring the set of web pages to be accessible to a web browser (e.g., web browser 218 of FIG. 2). In certain embodiments, providing the activity flow to a web browser can include configuring the set of web pages to be navigable by a user. For example, in certain embodiments, the web browser could include a software widget or extension configured to display the set of web pages.

In certain embodiments, providing the activity flow can include presenting a set of previous web page recommendations based on the web browsing information. The set of previous web page recommendations can be provided in response to a content request submitted by a user, such as a page load or a search query. As an example, consider that a user loads a first web page. In certain embodiments, the previous web page recommendations may be a set of web pages viewed by a threshold number of users prior to viewing the first web page. In certain embodiments, providing the activity flow can include presenting a set of subsequent web page recommendations. Providing the subsequent web page recommendations may be performed in response to a content request, such as a page load (e.g., a web page load) or a search query. For example, consider that a user loads a first web page. The subsequent web page recommendations may, in certain embodiments, represent a series of web pages viewed by a threshold number of users after viewing the first web page.

Consider the following example. In certain embodiments, a user may be part of a social network, and belong to a community of users researching renewable energy sources. The user may use a search engine to perform a web search for the term “renewable energy,” and load a web page related to wind energy. The method 300 can include providing the user with a set of web pages frequently viewed by other members of the renewable energy source community that are related to the topic of renewable energy. In certain embodiments, the set of web pages can be navigated by using a “back” button and a “forward” button of a web browser. By pressing the “back” button, the user can view web pages from the set of web pages that were viewed by other members of the renewable energy source community prior to viewing the current page related to wind energy. By pressing the “forward” button, the user can view web pages from the set of web pages that were viewed by other members of the renewable energy source community after viewing the current page related to wind energy.

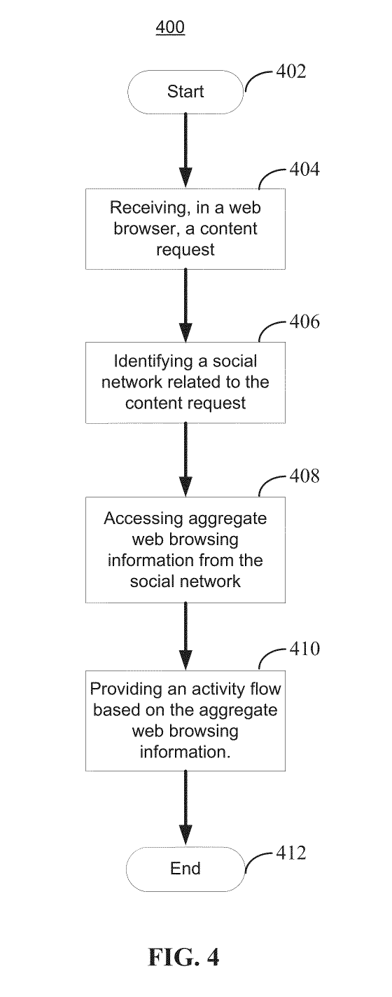

FIG. 4 is a flowchart illustrating a method 400 for creating a web browser activity flow, consistent with embodiments of the present disclosure. Aspects of FIG. 4 are directed toward providing an activity flow containing a set of recommended web pages to a web browser. The method 400 may begin at block 402 and end at block 412. Consistent with various embodiments, the method 400 can include a receiving block 404, an identifying block 406, an accessing block 408 and a providing block 410.

Consistent with various embodiments, at block 404 the method 400 can include receiving, in a web browser, a content request. The content request may, for example, be a page load (e.g., a web page load) or a search query. Other types of content requests are also possible. The content request may be received in a dialog box or a URL entry window of the web browser. In certain embodiments, the content request may be input by a user.

At block 406, the method 400 can include identifying a social network related to the content request. In certain embodiments, identifying the social network can include analyzing search terms (e.g., syntactic and semantic elements of the search terms, the order and placement of terms, etc.), cookies including expiration timestamps, and metadata associated with a web page, and cross-reference this information with one or more social servers of which the user is a member. For example, the social network may host one or more communities or user groups related to a topic or subject matter of the content request. In certain embodiments, the user who entered the content request may be a member of one or more communities of the social network. For example, in certain embodiments, a user who belongs to a community related to accordions on a social network may load a web page related to accordions. The method 400 can include identifying the social network that hosts the accordion community to which the user belongs.

Consistent with various embodiments, at block 408 the method 400 can include accessing aggregate web browsing information from the social network. In certain embodiments, the method 400 can include requesting the aggregate web browsing information from the social network. For example, requesting the web browsing information from the social network can include using an application programming interface configured to access a browsing information database. Further, collecting the web browsing information from the first set of web pages can include using a linking token communicatively connected to a web browsing and a browsing information database. The web browsing information can be aggregate browsing data and statistics gathered from a group of users, and may represent browsing trends and tendencies of the group of users. In certain embodiments, the web browsing information can be browsing history gathered from individual web browsers and stored within a social browsing system (such as social browsing system 256 of FIG. 2). The web browsing information may include information regarding popular web sites frequently visited by the group of users. In certain embodiments, block 408 of method 400 can correspond to block 304 of method 300.

Consistent with various embodiments, at block 410 the method 400 can include providing an activity flow for a web browser based on the aggregate web browsing information. In certain embodiments, the activity flow may include a set of recommended web pages related to a particular topic or subject matter. In certain embodiments, the activity flow may be based on aggregate browsing information from a social group or community hosted by a social network. The set of web pages may be ordered to indicate the sequence in which they were viewed by a threshold number of users. In certain embodiments, providing the activity flow to a web browser can include configuring the set of web pages to be navigable by a user. For example, in certain embodiments, the web browser could include a software widget or extension configured to display the set of web pages.

Consider the following example. A user may be a member of a social network specializing in business networking and connecting individuals with employment opportunities. The user may be searching for employment opportunities in the software development field, and may be a member of a software development user community hosted by the social network. The user may load a profile page of a hiring manager at a company that focuses on software development. In response to loading the profile page, the method 400 can retrieve aggregate web browsing information of the users belonging to the software development user community, and generate an activity flow. The activity flow may, in certain embodiments, be a set of web pages related to networking contacts and employment opportunities in the field of software development. In certain embodiments, the web pages may be organized in the order in which they were viewed by the users of the software development user community, and the user may navigate the pages using “back” and “forward” buttons of his or her web browser. Pressing the “back” button may take the user to a page viewed by the users of the software development user community prior to viewing the present page, and pressing the “forward” button may take the user to a page viewed by the users of the software development user community after viewing the present page.

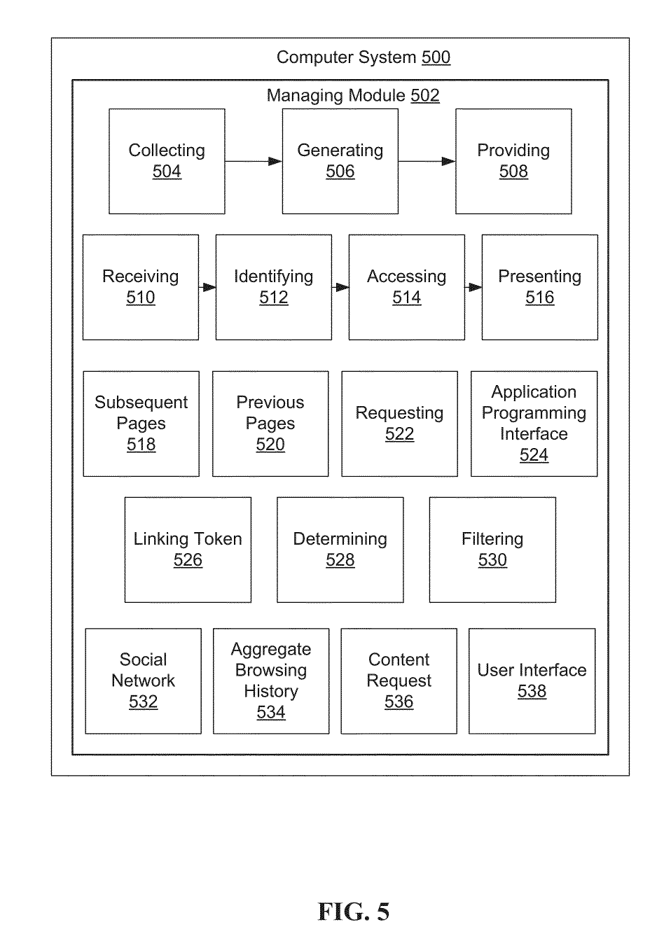

FIG. 5 illustrates modules of a system for creating an activity flow, consistent with embodiments of the present disclosure. Consistent with various embodiments, method 300 and method 400 can be implemented using one or more modules of FIG. 5. These modules can be implemented on hardware, software, or firmware executable on hardware, or a combination thereof. For example, these modules may be implemented on an example computer system 500.

The computer system 500 can include a managing module 502. The managing module 402 can be configured to manage an activity flow. The managing module 502 can include a collecting module 504, a generating module 506, a providing module 508, a receiving module 510, an identifying module 512, an accessing module 514, a presenting module 516, a subsequent pages module 518, a previous page module 520, a requesting pages module 522, an application programming interface module 524, a linking token module 526, a determining module 528, a filtering module 530, a social network module 532, an aggregate browsing history module 534, a content request module 536, and a user interface module 538.

The collecting module 504 can include collecting web browsing information for a first set of web pages. Collecting web browsing information can include using a requesting module 522 configured to request the web browsing information from the first set of web pages. For example, requesting the web browsing information from the first set of web pages can include using an application programming interface module 524 configured to access a browsing information database. Further, collecting the web browsing information from the first set of web pages can include using a linking token module 526 communicatively connected to a web browsing and a browsing information database.

The generating module 506 can be configured to generate a web browser activity flow based on the web browsing information. The web browser activity flow can include a second set of web pages. The web browsing information may, as an example, be an aggregated browsing history retrieved from individual web browsers accessing the first set of web pages. An aggregated browsing history module 534 can be configured to retrieve the web browsing information. The determining module 528 can be configured to determine, using an activity flow processing engine, that a first subset of the second set of web pages is unrelated to a first topic of the second set of web pages. Further, filtering module 530 can be configured to filter the second set of web pages to remove the first subset. Filtering the second set of web pages can be performed in response to determining that the first subset of the second set of web pages is unrelated to the first topic of the second set of web pages.

The providing module 508 can be configured to provide the web browser activity flow to a web browser. The web browser may, for instance, be active on a computer, tablet, smart phone, or other device. Providing the activity flow can include generating, using a subsequent pages module 518, a set of subsequent web page recommendations based on the browsing information. Further, providing the activity flow can include generating, using a previous pages module 520, a set of previous web page recommendations based on the web browsing information. Generating the subsequent web pages recommendations and the previous web page recommendations can be performed in response to a content request.

The receiving module 510 can be configured to receive a content request. The content request may, for instance, be a page load (e.g., a web page load) or a search query. The content request can be managed using the content request module 536. The identifying module 512 can be configured to identify a social network related to the content request. In certain embodiments, identifying the social network can include analyzing metadata associated with the content request and a catalog of known social networks.

The accessing module 514 can be configured to access aggregate web browsing information from the social network. Accessing web browsing information can include using a requesting module 522 configured to request the web browsing information from the social network. For example, requesting the web browsing information from the social network can include using an application programming interface module 524 configured to access a browsing information database. Further, accessing the web browsing information from the social network can include using a linking token module 526 communicatively connected to a web browsing and a browsing information database.

The presenting module 516 can be configured to provide the web browser activity flow to a web browser. The web browser may, for instance, be active on a computer, tablet, smart phone, or other device. Providing the activity flow can include generating, using a subsequent pages module 518, a set of subsequent web page recommendations based on the browsing information. Further, providing the activity flow can include generating, using a previous pages module 520, a set of previous web page recommendations based on the web browsing information. Generating the subsequent web pages recommendations and the previous web page recommendations can be performed in response to a content request. In certain embodiments, the activity flow can be navigated using a user interface communicatively connected to the web browser. The web browser may be managed using a user interface module 538.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A computer-implemented method for creating a web browser activity flow, the method comprising:
sending, to a browser information database, a content request related to a first topic wherein the content request is sent by a client device;
collecting, from the browsing information database having one or more web pages related to the first topic, web browsing information including an aggregated web page browsing history from a plurality of individual web browsers that access the browsing information database;
selecting a set of web pages from the aggregated web page browsing history based on the web browsing information and the content request;
generating a web browser activity flow having the set of web pages; and
providing the web browser activity flow to a web browser of the client device.

2. The method of claim 1, wherein collecting further comprises requesting web browsing information related to the first topic from the one or more web pages of the web browsing database.

3. The method of claim 2, wherein requesting the web browsing information related to the first topic from the one or more web pages of the web browsing database further comprises:
accessing the browsing information database using an application programming interface configured to instantiate, in response to requesting the web browsing information from the one or more web pages, a web browsing information acquisition protocol configured to process streamed web browsing data.

4. The method of claim 3, wherein the browsing information database having one or more web pages includes a social networking site, the social network site including at least one user community related to the first topic.

5. The method of claim 1, wherein collecting includes using a linking token communicatively connected to a web browser and the browsing information database, wherein the linking token is configured to transmit web browsing information data packets to the web browser in response to initiating the web browser.

6. The method of claim 1, wherein the activity flow includes a set of subsequent web page recommendations based on the web browsing information, wherein the set of subsequent web page recommendations have a view count greater than a threshold view count value.

7. The method of claim 1, wherein the activity flow includes a set of previous web page recommendations based on the web browsing information, wherein the set of previous web page recommendations have a view count greater than a threshold view count value.

8. The method of claim 1, further comprising:
determining, by an activity flow processing engine, that a first subset of the set of web pages is unrelated to a first topic of the set of web pages;
filtering, in response to determining that a first subset of the set of web pages is unrelated to a first topic of the set of web pages, the set of web pages to remove the first subset; and
providing a second subset of the set of web pages that is related to the first topic of the set of web pages.

9. A computer-implemented method for creating an activity flow for a web browser, the method comprising:
receiving, in a web browser, a content request;
identifying a social network related to the content request;
accessing aggregate web browsing information from the social network; and
providing, based on the aggregate web browsing information, an activity flow having a set of web pages.

10. The method of claim 9, wherein the content request is one of a first web page load or a search query.

11. The method of claim 9, wherein providing the activity flow further comprises generating, in response to the content request, a set of subsequent web page recommendations based on the web browsing information, wherein the set of subsequent web page recommendations have a view count greater than a threshold view count value.

12. The method of claim 9, wherein providing the activity flow further comprises generating, in response to the content request, a set of previous web page recommendations based on the web browsing information, wherein the set of previous web page recommendations have a view count greater than a threshold view count value.

13. The method of claim 9, wherein the activity flow is accessed by a user interface in the web browser.

14. The method of claim 9, wherein accessing aggregate web browsing information from the social network further comprises requesting the aggregate web browsing information from the social network.

15. The method of claim 14, wherein requesting the aggregate web browsing information from the social network includes using an application programming interface configured to access a browsing information database, wherein the application programming interface is configured to instantiate, in response to requesting the aggregate web browsing information from the social network, a web browsing information acquisition protocol configured to process streamed data.

16. The method of claim 9, wherein accessing the aggregate web browsing information includes using a linking token communicatively connected to a web browser and a browsing information database, wherein the linking token is configured to transmit web browsing information data packets to the web browser in response to initiating the web browser.

17. The method of claim 9, further comprising:
determining, by an activity flow processing engine, that a first subset of the set of web pages is unrelated to a first topic of the set of web pages;
filtering, in response to determining that a first subset of the set of web pages is unrelated to a first topic of the set of web pages, the set of web pages to remove the first subset; and
providing a second subset of the set of web pages that is related to the first topic of the set of web pages.

18. A computer program product comprising a computer readable storage medium having a computer readable program stored therein, wherein the computer readable program, when executed on a first computing device, causes the first computing device to:
send, to a browser information database, a content request related to a first topic wherein the content request is sent by a client device;
collect, from a browsing information database having one or more web pages related to the first topic, web browsing information including an aggregated web page browsing history from a plurality of individual web browsers that access the browsing information database;
select a set of web pages from the aggregated web page browsing history based on the web browsing information and the content request;
generate a web browser activity flow having the set of web pages; and
provide the web browser activity flow to a web browser of the client device.

19. The computer program product of claim 18, further comprising computer readable program code configured to generate, in response to a content request:
a set of subsequent web page recommendations based on the web browsing information, wherein the set of subsequent web page recommendations have a view count greater than a threshold view count value; and
a set of previous web page recommendations based on the web browsing information, wherein the set of previous web page recommendations have a view count greater than a threshold view count value.

20. The computer program product of claim 18, further comprising:
computer readable program code to access the browsing information database using an application programming interface, wherein the application programming interface is configured to instantiate a web browsing information acquisition protocol for processing streamed web browsing data;
computer readable program code to determine, by an activity flow processing engine communicatively connected with the application programming interface, that a first subset of the set of web pages is unrelated to a first topic of the set of web pages;
computer readable program code to filter, in response to determining that the first subset of the set of web pages is unrelated to the first topic of the set of web pages, the set of web pages to remove the first subset; and
computer readable program code to provide a second subset of the set of web pages that is related to the first topic of the set of web pages.
